(19) United States
(12) Patent Application Publication
(10) Pub. No.: US 2016/0281747 A1
(43) Pub. Date: Sep. 29, 2016

(54) ACTUATOR DEVICE

(71) Applicant: SIEMENS AKTIENGESELLSCHAFT, München (DE)

(72) Inventors: Georg Bachmaier, München (DE); Gerit Ebelsberger, München (DE); Reinhard Freitag, München (DE); Andreas Gödecke, München (DE); Wolfgang Zöls, München-Lochhausen (DE)

(21) Appl. No.: 14/777,962

(22) PCT Filed: Jan. 15, 2014
(86) PCT No.: PCT/EP2014/050729

§ 371 Date: Sep. 17, 2015

(30) Foreign Application Priority Data
Mar. 12, 2013 (DE) 10 2013 205 044.5

(51) Int. Cl. F15B 15/10; F15B 15/14

(52) U.S. Cl. CPC F15B 15/10; F15B 15/14

(57) ABSTRACT

The embodiments relate to an actuator device including a drive unit and an output unit. The output unit includes a first translation unit having a first output and a second translation unit, connected in a fluid manner to the first translation unit via a pipeline system, having a second output. The drive unit is connected to the pipeline system in a fluid manner. To deflect the outputs, a fluid may be exchanged between the first translation unit and the second translation unit by the drive unit. The first translation unit and the second translation unit each have a pre-clamping element. The pre-clamping elements are supported in the opposite direction against a movably mounted clamping.

### CROSS-REFERENCE TO RELATED APPLICATIONS

The present patent document is a §371 nationalization of PCT Application Serial Number PCT/EP2014/050729, filed Jan. 15, 2014, designating the United States, which is hereby incorporated by reference, and this patent document also claims the benefit of DE 10 2013 205 044.5, filed on Mar. 21, 2013, which is also hereby incorporated by reference.

### TECHNICAL FIELD

The present embodiments relate to an actuator device.

### BACKGROUND

Certain actuator devices have the task of realizing a required deflection in a defined range. To this end, the actuator device has to make a movement both to and fro possible. In order to provide a movement in both directions, the hydraulic liquid contained in the actuator device is prestressed. The prestress varies with the deflection in known actuator devices. This leads to pressure differences that limit the maximum possible deflection, and to inconsistent force development.

### SUMMARY AND DESCRIPTION

The scope of the present invention is defined solely by the appended claims and is not affected to any degree by the statements within this summary. The present embodiments may obviate one or more of the drawbacks or limitations in the related art.

The present embodiments are based on the object of eliminating these disadvantages and providing an improved actuator device.

The actuator device has a drive unit and an output unit. The output unit includes a first translation unit with a first output and a second translation unit with a second output, wherein the second translation unit is fluidly connected to the first translation unit via a line system. The drive unit is fluidly connected to the line system. In order to deflect the outputs, a fluid may be exchanged by the drive unit between the first translation unit and the second translation unit. The first translation unit and the second translation unit have in each case one prestressing element. The prestressing elements are supported in opposite directions against the movably mounted clamp.

As a result of the movable mounting of the clamp, the component is moved by way of the two outputs. No differential force between the two prestressing elements is advantageously produced as a result. The pressures in the fluid chambers therefore remain constant independently of the stroke. As a result, firstly the force of the actuator device may be kept constant independently of the deflection, since the pressure difference of the fluid is not changed. Secondly, the maximum stroke may therefore also be increased considerably.

In one advantageous refinement of the actuator device, the first translation element and the second translation element have a hydraulic cross section of identical dimensions.

As a result, the deflections of the two outputs have the same travels. The clamp therefore moves uniformly with respect to the deflections of the two outputs.

In a further advantageous refinement of the actuator device, the first prestressing element and the second prestressing element have an identical prestressing force. In addition, the first prestressing element and the second prestressing element may have an identical spring rate.

As a result, a symmetrical system is achieved having the same properties in both directions. The use of the actuator device in a module is therefore simplified.

In a further advantageous refinement of the actuator device, the first translation element and/or the second translation element are/is a hydraulic cylinder.

Hydraulic cylinders advantageously have a very low longitudinal stiffness and therefore do not influence the spring rates of the prestressing elements. In addition, hydraulic cylinders may be designed for long deflections.

In an alternative advantageous refinement of the actuator device, the first translation element and/or the second translation element are/is a bellows. Here, the bellows is advantageously a metal bellows or a diaphragm bellows, the bellows having the same spring rate.

A high system tightness may be achieved relatively simply by way of a bellows, e.g., a metal bellows. In addition, bellows have a relatively low weight.

In a further advantageous refinement of the actuator device, the fluid chambers and the fluid lines are filled completely with a hydraulic liquid.

The fluid is therefore substantially incompressible and uniform operation of the actuator device is provided at different high pressures in the system.

### BRIEF DESCRIPTION OF THE DRAWINGS

Exemplary embodiments are explained in greater detail using the drawings and the following description.

FIG. 1 depicts an example of an actuator device.

FIGS. 2 to 4 depict translation units of the actuator device in various refinements.

### DETAILED DESCRIPTION

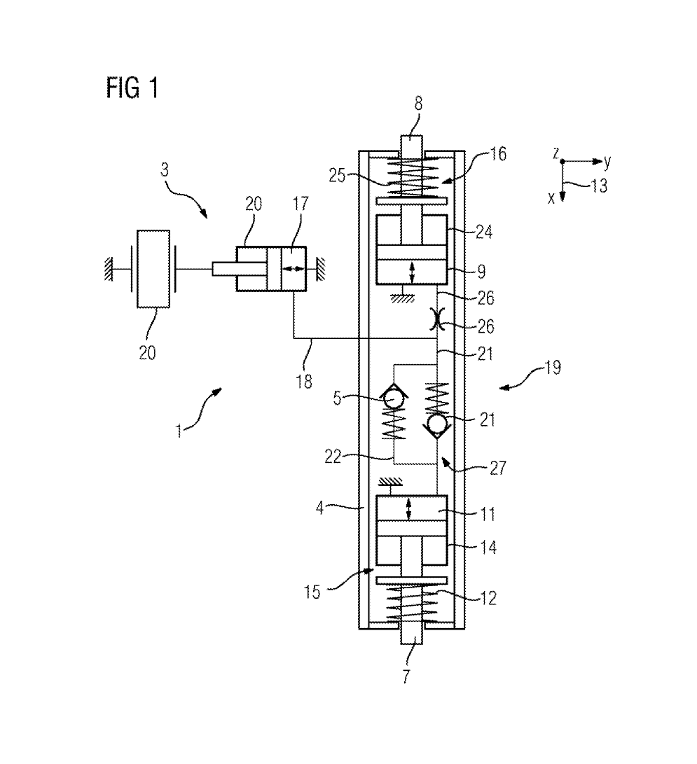

FIG. 1 outlines by way of example an actuator device 1 in a coordinate system 13. The actuator device 1 includes a drive unit 3 and an output unit 19 connected to the drive unit 3 in a fluid-conducting manner by a first fluid line 18.

The drive unit 3 includes an actuator 2 and a drive element 20. The drive element 20 has a drive fluid chamber 17.

The actuator 2 may be, for example, a piezoelectric actuator 2 or a magnetoresistive actuator 2. The drive unit 3 is configured in such a way that the magnitude of the volume of the drive fluid chamber 17 may be influenced by way of the deflection of the actuator 2.

To this end, the actuator 2 is connected to the drive element 20 in a non-positive manner at least in the pressing direction. The actuator 2 may also be connected to the drive element 20 in a positively locking manner. The actuator may also be connected to the drive element 20 in a non-positive manner in the opposite direction to the pressing direction, which is to say in the pulling direction. Here, the pressing direction represents the direction of the deflection of the actuator 2.

As depicted in FIG. 1, a pressing force is exerted on the drive element 20 by way of an increase in the deflection of the actuator 2. The volume of the drive fluid chamber 17 is decreased by way of an increase in the deflection of the actuator 2. The volume of the drive fluid chamber 17 may at least be increased by way of a reduction in the deflection of the actuator 2. In the case of a non-positive connection of the actuator 2 to the drive element 20 in the pulling direction, the volume of the drive fluid chamber 17 is increased by way of a reduction in the deflection of the actuator 2. The relationship between the deflection of the actuator 2 and the volume of the drive fluid chamber 17 may also be reversed in principle by way of a direction change at the drive element 20.

The drive element 20 may be, for example, a hydraulic cylinder with a piston, a bellows, in particular a metal bellows or else a diaphragm bellows. FIG. 1 depicts, by way of example, a hydraulic cylinder 20 as the drive element 20, the actuator 2 being connected to the piston thereof in a non-positive manner.

The drive fluid chamber 17 is adjoined by the first fluid line 18. In the case of a reduction in the volume of the drive fluid chamber 17, a fluid situated in the drive fluid chamber 17 flows through the first fluid line 18 to the output unit 19. In the case of an increase in the volume of the drive fluid chamber 17, the fluid may flow into the drive fluid chamber 17.

The output unit 19 has a first translation unit 15 and a second translation unit 16. The first translation unit 15 is fluidly connected to the second translation unit 16.

The first translation unit 15 has an output fluid chamber 11, a first translation element 14, a first output 7 and a first prestressing element 12. In addition, the second translation unit 16 has a reserve fluid chamber 9, a second translation element 24, a second output 8 and a second prestressing element 25.

As depicted in FIG. 1, the first translation element 14 and the second translation element 24 are configured as hydraulic cylinders 14, 24, and the prestressing elements 12, 25 are configured as helical springs 12, 25. As is customary, the hydraulic cylinders 14, 24 have a displaceable piston. Here, the piston forms in each case the output 7, 8. The volume of the fluid chambers 11, 9 is determined in each case according to the position of the outputs 7, 8, or the deflection of the outputs 7, 8 is dependent in each case on the volume of the fluid chambers 11, 9. The prestressing elements 12, 25 in each case exert a prestress on the outputs 7, 8, on the piston 7, 8 here.

The first prestressing element 12 and the second prestressing element 25 are both supported on a clamp 4. To this end, the prestressing elements 12, 25 are arranged in a substantially opposed manner. The prestressing elements 12, 25 work in one line. The clamp 4 is rigid and may be moved freely. The clamp 4 is mounted in a floating manner. The prestressing elements 12, 25 act against one another in such a way that a force equilibrium is produced between the exerted force of the first prestressing element 12 and the exerted force of the second prestressing element 25. The clamp 4 may be moved in the direction of the deflections of the outputs 7, 8. The clamp 4 moves with the outputs 7, 8.

The output fluid chamber 11 of the first translation unit 15 is fluidly connected to the reserve fluid chamber 9 of the second translation unit 16 by a line system 27. The line system is configured in such a way that a second fluid line 21 and a third fluid line 22 are arranged parallel to one another and a fourth fluid line 26 is arranged in series with respect to the second and third fluid line 21, 22. A suction check valve 6 is arranged in the second fluid line 21. A delivery check valve 5 is arranged in the third fluid line 22. The suction check valve 6 closes in the suction direction and the delivery check valve 5 closes in the delivery direction in an opposed manner to the suction direction. The check valves 5, 6 are arranged in an opposed manner with respect to one another. The check valves 5, 6 open in each case only in one direction; the suction check valve 6 opens in the delivery direction and the delivery check valve 5 opens in the suction direction. The check valves 5, 6 are prestressed, with the result that opening takes place only above a defined prevailing pressure. The first fluid line 18 is fluidly connected to the fourth fluid line 26 at a coupling point 23.

In the exemplary embodiment according to FIG. 1, the second fluid line 21 is arranged at the output fluid chamber 11 and the fourth fluid line 26 is arranged at the reserve fluid line 9. The fourth fluid line 26 may be provided additionally with a throttle 10 that constricts the cross section of the fourth fluid line 26.

The fluid chambers 9, 11, 17 and fluid lines 18, 21, 22, 26 are filled with a fluid, (e.g., a hydraulic liquid such as silicone oil or glycerin).

The fluid may be exchanged between the first translation unit 15 and the second translation unit 16 by to and fro movements of the drive unit 3. The outputs 7, 8 are deflected in this way. Depending on a speed, at which the deflection of the actuator 2 is performed, the fluid may be conducted from the reserve fluid chamber 9 into the output fluid chamber 11 or in the reverse direction from the output fluid chamber 11 into the reserve fluid chamber 9.

In order to conduct the fluid through the second or third fluid line 21, 22, a higher prevailing pressure is provided on account of the prestressed check valves 5, 6 than for conducting the fluid through the fourth fluid line 26. The prevailing pressure refers to a pressure difference between the inlet side and the outlet side of the valve. The prevailing pressure rises with the speed of the deflection of the actuator 2.

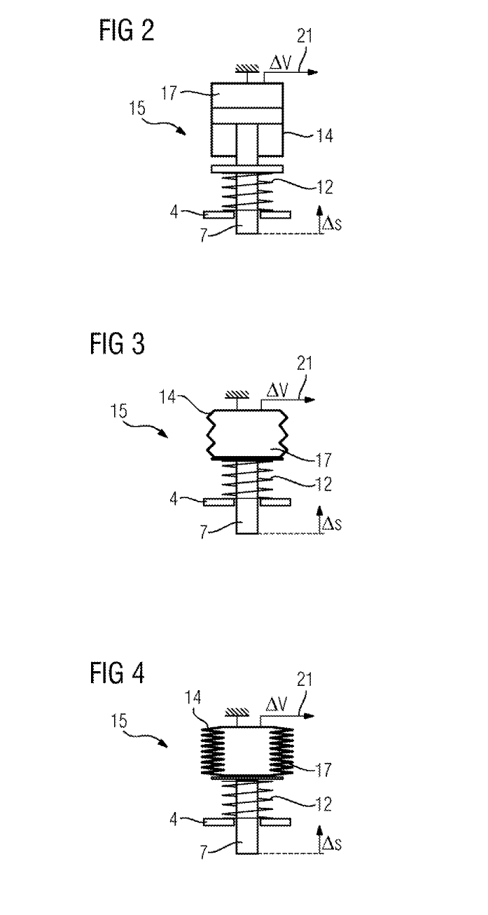

FIGS. 2 to 4 depict design variants of the translation units 15, 16, in each case using the example of the first translation unit 15. The output 7 is prestressed by the prestressing unit 12. The prestressing unit 12 is supported on the clamp 4. A corresponding volume change ΔV of the output fluid chamber 17 accompanies the movement of the output 7 by the distance Δs. A fluid mass flow takes place through the fluid line 21.

Like FIG. 1, FIG. 2 depicts a hydraulic cylinder as translation unit 15. The piston of the hydraulic cylinder is the output 7.

In FIG. 3, the translation unit 15 is a metal bellows and, in FIG. 4, the translation unit 15 is a diaphragm bellows. Here, the output 7 is formed in each case by a piston 7 that bears against the bellows.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An actuator device comprising:
a drive unit; and
an output unit, the output unit comprising a first translation unit with a first output and a second translation unit with a second output,
wherein the second translation unit is fluidly connected to the first translation unit via a line system,
wherein the drive unit is fluidly connected to the line system,
wherein the actuator device is configured for a fluid to be exchanged by the drive unit between the first translation unit and the second translation unit in order to deflect the first and second outputs, and
wherein the first translation unit and the second translation unit each individually comprise a prestressing element, wherein the prestressing elements are supported in opposite directions against a movably mounted clamp.

2. The actuator device as claimed in claim 1, wherein the first translation element and the second translation element comprise a hydraulic cross section of identical dimensions.

3. The actuator device as claimed in claim 2, wherein the first prestressing element and the second prestressing element comprise an identical spring rate.

4. The actuator device as claimed in claim 3, the first prestressing element (12) and the second prestressing element (25) having an identical prestressing force.

5. The actuator device as claimed in claim 1, wherein the first translation element or the second translation element is a hydraulic cylinder, or wherein the first and the second translation elements are hydraulic cylinders.

6. The actuator device as claimed in claim 1, wherein the first translation element, the second translation element, or the first and the second translation elements are bellows.

7. The actuator device as claimed in claim 6, wherein the bellows are metal bellows or diaphragm bellows, the bellows having a same spring rate.

8. The actuator device as claimed in the claim 1, wherein fluid chambers and fluid lines of the actuator device are completely filled with a hydraulic liquid.

9. The actuator device as claimed in claim 2, wherein the first translation element or the second translation element is a hydraulic cylinder, or wherein the first and the second translation elements are hydraulic cylinders.

10. The actuator device as claimed in claim 3, wherein the first translation element or the second translation element is a hydraulic cylinder, or wherein the first and the second translation elements are hydraulic cylinders.

11. The actuator device as claimed in claim 4, wherein the first translation element or the second translation element is a hydraulic cylinder, or wherein the first and the second translation elements are hydraulic cylinders.

12. The actuator device as claimed in claim 2, wherein the first translation element, the second translation element, or the first and the second translation elements are bellows.

13. The actuator device as claimed in claim 3, wherein the first translation element, the second translation element, or the first and the second translation elements are bellows.

14. The actuator device as claimed in claim 4, wherein the first translation element, the second translation element, or the first and the second translation elements are bellows.

15. The actuator device as claimed in claim 2, wherein the fluid chambers and the fluid lines are completely filled with a hydraulic liquid.

16. The actuator device as claimed in claim 3, wherein fluid chambers and fluid lines of the actuator device are completely filled with a hydraulic liquid.

17. The actuator device as claimed in claim 4, wherein fluid chambers and fluid lines of the actuator device are completely filled with a hydraulic liquid.

18. The actuator device as claimed in claim 5, wherein fluid chambers and fluid lines of the actuator device are completely filled with a hydraulic liquid.

19. The actuator device as claimed in claim 6, wherein fluid chambers and fluid lines of the actuator device are completely filled with a hydraulic liquid.
